(19) United States
(12) Patent Application Publication
(10) Pub. No.: US 2025/0276264 A1
(43) Pub. Date: Sep. 4, 2025

(54) SELF-SUPPORTING FILTER MEDIA

(71) Applicant: DelStar Technologies, Inc, Alpharetta, GA (US)

(72) Inventor: Yasar Kiyak, Middletown, DE (US)

(21) Appl. No.: 19/065,383

(22) Filed: Feb. 27, 2025

Related U.S. Application Data
(60) Provisional application No. 63/560,813, filed on Mar. 4, 2024.

(51) Int. Cl. B01D 39/20; B01D 46/52

(52) U.S. Cl. CPC B01D 39/2068; B01D 46/521; B01D 2239/02; B01D 2239/0627

(57) ABSTRACT

Nonwoven material, self-supporting filter media and filters, such as residential and commercial air filters, are provided that comprise a plurality of fibers with a silicone-based coating. The silicone-based coating comprises a silicone compound having an add-on weight of at least about 1.0 gsm. The silicone-based coating increases the efficiency of the filter media at capturing contaminants, particularly contaminants in the E2 and E3 particle group range, without compromising other important characteristics of the filter, such as longevity, dust holding capacity, pressure drop or air permeability. In addition, the filter media allows for the production of self-supporting filters having a Minimum Efficiency Reporting Value of at least MERV 8 that are fully incinerable because they do not include a metal wire backing to hold the shape of the pleats.

### CROSS-REFERENCE TO RELATED APPLICATIONS

This application claims the benefit of U.S. Provisional Application Ser. No. 63/560,813, filed Mar. 4, 2024, the complete disclosure of which is incorporated herein by reference for all purposes.

### TECHNICAL FIELD

This description generally relates to self-supporting filter media with improved performance characteristics and more particularly to self-supporting filter media incorporating silicon-based coatings.

### BACKGROUND

Liquid and gas filters trap contaminants of many different types from the air, water, or others. Air filters, for example, typically include a filtration media comprising fibrous or porous materials which remove solid particulates, such as dust, pollen, mold, and bacteria from the air.

Two main types of air filtration devices include surface filters and depth filters. Surface filters, such as membranes or films, act as a barrier for contaminants that are captured before they enter the media structure. These surface filters typically have a submicron pore size and narrow pore size distribution. Surface filters tend to have relatively high particle capturing efficiency. However, they also have a relatively high pressure drop and a low dust loading capacity. The high pressure drop results in reduced air flow through the filter. The low dust loading capacity significantly reduces the longevity of the filter. As such, surface filters have been used in a limited number of applications in the air filtration industry.

Depth filters are commonly employed in air filtration devices with a moderate to high efficiency, a low pressure drop, and a relatively high dust loading capacity. Depth filters generally employ various kinds of fibers that may be formed into a web or other nonwoven structure having tortuous paths between the fibers through which a gas stream, such as air, is passed. The particulate matter in the gas flowing through the paths in the web is retained on the upstream side of the web, or within the tortuous paths of the web due to the size of the particles relative to the paths' diameters.

Conventional residential and commercial air filters, such as HVAC filters, are typically rated by the filter's ability to capture particles between about 0.3 and 10 microns. This rating, referred to as a Minimum Efficiency Reporting Value or MERV is developed by the American Society of Heating, Refrigerating and Air Conditioning Engineers (ASHRAE). The MERV ratings range from 1-16, with higher values indicating higher efficiencies at trapping specific types of particles. It is also common to compare efficiency values depending on particle sizes within the air stream during testing. E3, E2, and E1 values refer to particulate efficiency at 3-10 microns, 1-3 microns and 0.3 to 1 micron, respectively.

A pleated filter is an air filter that is made from a pliable material, such as polyester, cotton or paper, that is folded to resemble an accordion and housed in a cardboard frame. The folds or pleats provide the filter with more surface area to capture particles. The back side of the pleated filter typically comprises a metal mesh to provide support to the front of the filter. Air flows in one direction from the front side into the metal mesh for proper support. Thus, these filters must typically be inserted into the HVAC system in one direction such that the front of the filter faces the air flow.

Recently, mechanical self-supporting filters have been developed that have pleats capable of holding their shape without a wire mesh backing. These filters typically comprise carded and air-through bonded fibers having a basis weight of about 130 gsm and are rated as MERV 8 under the ASHRAE standards. Self-supporting pleated filters are considered more environmentally friendly because they do not contain metal and thus are fully incinerable.

### SUMMARY

The following presents a simplified summary of the claimed subject matter in order to provide a basic understanding of some aspects of the claimed subject matter. This summary is not an extensive overview of the claimed subject matter. It is intended to neither identify critical elements of the claimed subject matter nor delineate the scope of the claimed subject matter. Its sole purpose is to present some concepts of the claimed subject matter in a simplified form as a prelude to the more detailed description that is presented later.

Nonwoven material for use with self-supporting filter media and filters, such as residential and commercial air filters, are provided that comprise a plurality of fibers with a silicone-based coating. Systems and methods of manufacturing such nonwoven material, filtration media and filters are also provided.

In one aspect, a nonwoven material comprises one or more fibers coated with a silicone-based coating. The silicone-based coating comprises a silicone compound having an add-on weight of at least about 1.0 gsm. The non-woven material may be used, for example, in a filter media comprising a layer, sheet or web of the fibers. The coating substantially improves the efficiency of the nonwoven material at capturing contaminants, particularly contaminants in the E2 and E3 particle group range, without substantially compromising other important characteristics of the material, such as longevity, dust holding capacity, pressure drop and air permeability.

In various embodiments, the add-on weight of the silicone-based coating is about 1.5 gsm to about 20 gsm, or about 1.5 gsm to about 15.5 gsm. In certain embodiments, the add-on weight may be about 2.9 gsm to about 10.9 gsm. In other embodiments, the add-on weight may be about 14 gsm to about 15.5 gsm.

In various embodiments, the layer of fibers has a basis weight of about 30 gsm to about 300 gsm, or about 60 gsm to about 200 gsm, or about 80 gsm to about 100 gsm, or about 85 gsm to about 95 gsm, or about 90 gsm.

The silicone-based coating may be at least about 1.5% of the total weight of the layer, or between about 1.5% and about 20%, or about 1.5% to about 15%. The total weight of the fibers and the silicone-based coating may be about 61 gsm to about 215 gsm, or about 81 gsm to about 125 gsm, or about 86 gsm to about 120 gsm, or about 91 gsm to about 115 gsm.

In various embodiments, the width of the layer of nonwoven material may be about 15 mils to about 150 mils, or about 15 mils to about 50 mils, or about 25 mils to about 40 mils.

The fibers may be staple fibers or continuous fibers. The fibers may be naked prior to application of the coating (i.e., zero spin finish). The fibers may include a spin finish prior to the application of the coating. In certain embodiments, the staple fibers have a conventional spin finish of less than about 2%.

The fibers can be manufactured by any suitable method, including, without limitation, meltblown, spunbond or spunlace, bicomponent spunbond, heat-bonded, carded, air-laid, wet-laid, extrusion, co-formed, needlepunched, stitched, hydraulically entangled or the like. In certain embodiments, the fibers are spunbond or meltblown fibers.

In an exemplary embodiment, the fibers comprise continuous spunbond fibers. Spunbond media is generally more cost effective than other manufacturing methods because it involves a relatively high throughput of the fibers.

The fibers may be artificial or natural. Suitable materials for the fibers include, but are not limited to, polyethylene terephthalate (PET), polypropylene (PP), polyester, coPET, polypropylene, polycaprolactam, polyamides, such as polyamide 6 (PA6), polyamide 6-6 (PA6-6), co-polyamides, polyesters, polyethylene, high density polyethylene (HDPE), polycarbonate, polyacrylate, polyacrylonitrile, polystyrene, styrene maleic anhydride, propylene, polyimide, polyether ketone, cellulose ester, polyamide, polylactic acid, acrylic, vinyl acetate, ethylene vinyl acetate, styrene-butadiene, ethylene/vinyl chloride, vinyl acetate copolymer, latex, epoxy, polyurethane, cellulose, styrene and combinations thereof. Other conventional fiber materials are contemplated. In an exemplary embodiment, the fibers comprise PET.

The fibers may have thicknesses that are suitable for the application. In some embodiments, the fibers have at least one dimension in the range of about 1 to about 10,000 micrometers or about 1 to about 1,000 micrometers or about 10 to 100 micrometers. The thickness of the fibers may also be measured in denier, which is a unit of measure in the linear mass density of fibers. In some embodiments, the fibers may have a linear density of about 1 denier to about 10 denier.

In certain embodiments, the fibers are monocomponent. In other embodiments, the fibers comprise biocomponent fibers having a core and a sheath. In embodiments, the core is eccentric with the sheath. In other embodiments, the core is concentric with the sheath.

In various embodiments, the silicone-based coating includes a silicone compound diluted in water or other suitable fluid such that the silicone compound comprises at least about two percent by weight of the coating, or at least about five percent by weight of the coating. In an exemplary embodiment, the silicone compound comprises about 10% by the weight of the coating.

In various embodiments, the silicone-based coating comprises a reactive silicone macroemulsion. The silicone emulsion may comprise, for example, dimethyl silicone emulsions, amino type silicone emulsions, organo-functional silicone emulsions, resin type silicone emulsions, film-forming silicone emulsions, or the like. In one embodiment, the reactive silicone macroemulsion comprises an amino functional polydimethylsiloxane and/or a polyethylene glycol monotridecyl ether. In an exemplary embodiment, the amino functional polydimethylsiloxane comprises about 30 to about 40 percent by weight of the coating. In embodiments, the polyethylene glycol monotridecyl ether comprises about 5 to about 10 percent by weight of the coating.

In some embodiments, the silicone-based coating further comprises an antistatic agent. The antistatic agent may comprise a cationic antistatic agent, an anionic antistatic agent, a quaternary antistatic agent, or a surfactant. The surfactant may comprise a non-rewetting thermodegradable surfactant/foaming agent.

In various embodiments, the silicone-based coating is applied by any suitable process including, but not limited to, spraying the fibers with the silicone-based coating, dipping the fibers in a vessel containing the silicone-based coasting, applying the silicone-based coating as a foam to the fibers, utilizing a metering rod or other leveling device to apply the coating, delivering the coating on the fibers with a coating head, such as a slot-die, or any combination of these techniques. The coating may be applied as a spin finish, or after a spin finish has been applied. The coating may be applied to naked fibers that have no spin finish. The coating may be applied to the staple fibers on which a typical spin finish is already applied.

In certain embodiments, the silicone-based coating is applied by dipping or spraying. In an exemplary embodiment, the coating is sprayed onto the fibers. Spray coating is particularly cost effective because it does not use as much water as other methods and is relatively easy to dry. In addition, spray coating is environmentally friendly because it uses less water and does not require the use of additional chemicals.

In another aspect, a self-supporting filter is provided having a filter media comprising one or more fibers coated with a silicone-based coating. The coating has an add-on weight of at least about 1.0 gsm.

In various embodiments, the self-supporting filter comprises an air filter, such as an HVAC filter or the like, with one or more pleats, folds, or creases extending across a surface of the filter media. The term “self-supporting” is defined herein to mean that the filter does not include a metal wire backing to hold the shape of the pleats. Thus, the media preferably has a Gurley stiffness of about 1,000 mg to about 16,000 mg in machine direction (MD), or about 2,500 mg to about 16,000 mg, or about 3,000 mg to about 16,000. The Gurly stiffness is calculated using a Gurley stiffness tester meeting industry standards TAPPI #T543 OM-16 (2016) and ASTM D6125-97 (2007). These filters are more environmentally friendly because do not contain metal and thus are fully incinerable.

In various embodiments, the self-supporting filter has a Minimum Efficiency Reporting Value or MERV of at least MERV 5, or at least about MERV 8 according to ASHRAE 52.2. In some embodiments, the MERV rating is at least MERV 9, or at least MERV 10.

In various embodiments, the filter media has an E3 filtration efficiency of about 30%, or at least about 50%, or at least about 60%. In some embodiments, the filter media has an E3 filtration efficiency of greater than 70%. The filter media has an E2 filtration efficiency of at least about 20%, or at least about 25%, or at least about 30%, or at least about 35%. In some embodiments, the filter media has E2 filtration efficiency of greater than 40%.

In various embodiments, the silicon-based coating is dip coated onto the fibers and the filter media has an E3 filtration efficiency of greater than about 70% and a MERV rating of at least 8. The basis weight of the dip coated fibers may be about 1.5 gsm to about 15.5 gsm, or about 2.9 gsm to about 10.9 gsm. In other embodiments, the coating is sprayed onto the fibers and the filter media has an E3 filtration efficiency of at least about 75%, an E2 filtration efficiency of at least about 41%, and a MERV rating of at least 8, or 9. The basis weight of the spray coated fibers may be about 1.5 gsm to about 15.5 gsm or about 14 gsm to about 15.5 gsm.

In embodiments, the filter media comprises a pressure drop of about 0.10 inch H²O to about 0.2 inch H²O at 180 fpm, or about 0.11 inch H²O to about 0.13 inch H²O at 180 fpm. The filter media may have an air permeability of about 300 cfm to about 700 cfm at 125 Pa, or about 490 cfm to about 540 cfm at 125 Pa.

The recitation herein of desirable objects which are met by various embodiments of the present description is not meant to imply or suggest that any or all of these objects are present as essential features, either individually or collectively, in the most general embodiment of the present description or any of its more specific embodiments.

### BRIEF DESCRIPTION OF THE DRAWINGS

The accompanying drawings, which are incorporated in and constitute a part of this specification, illustrate several embodiments of the disclosure and together with the description, explain the principles of the disclosure.

FIG. 1 is a cross-sectional view of a self-supporting filter comprising a nonwoven material described herein;

FIG. 2 is a graph of the E3 particle group efficiency percentage (at 180 fpm) versus the add-on (gsm) of a silicone coating for various testing samples; and

FIG. 3 is a graph of the pressure drop (PD) in inch H²O (at 180 fpm) versus the add-on (gsm) of a silicone coating for various testing samples.

### DETAILED DESCRIPTION OF THE EMBODIMENTS

This description illustrates exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Nonwoven material for use with self-supporting filter media and filters, such as gas filters, face masks, CPAP filters, vacuum bags, cabin air filters, HVAC furnace filters, residential and commercial air filters, gas turbine, and compressor air intake filters, pre-filters, panel filters and the like, are provided that include fibers having a silicone-based coating. Systems and methods of manufacturing such nonwoven material, filter media and filters are also provided.

The silicone-based coating includes a silicone compound diluted in water or other suitable fluid such that the silicone compound comprises at least about 2 percent by weight of the coating, or at least about five percent by weight of the coating. In an exemplary embodiment, the silicone compound comprises about 10% by the weight of the coating. In an exemplary embodiment, the silicone compound comprises a silicone material, a surfactant, and water. The silicone and surfactant may together comprise about 10% weight of the overall coating.

The applicant has discovered that directly coating the fibers (as opposed to applying the coating to an outer surface of the already-formed filter media) with the silicone-based coating described herein substantially improves the efficiency of such filters at capturing contaminants, particularly contaminants in the E2 and E3 particle group range. In addition, this coating does not substantially compromise other important characteristics of the filters, such as cost, longevity, dust holding capacity, and the pressure drop or air permeability of the filter.

In embodiments, the silicone-based coating comprises a reactive silicone macroemulsion. Silicone emulsions are insoluble silicones substantially evenly dispersed in water with the aid of a surfactant. The silicone emulsion may comprise, for example, dimethyl silicone emulsions, amino type silicone emulsions, organo-functional silicone emulsions, resin type silicone emulsions, film-forming silicone emulsions or the like. In an exemplary embodiment, the reactive silicone macroemulsion comprises an amino functional polydimethylsiloxane and/or a polyethylene glycol monotridecyl ether. In embodiments, the amino functional polydimethylsiloxane comprises about 30 to about 40 percent by weight of the coating. In embodiments, the polyethylene glycol monotridecyl ether comprises about 5 to about 10 percent by weight of the coating

In embodiments, the silicone-based coating further comprises an antistatic agent. The antistatic agent may comprise a surfactant. The surfactant may comprise a non-rewetting thermodegradable surfactant/foaming agent.

In various embodiments, the add-on weight of the silicone-based coating is about 1.0 gsm to about 20 gsm, or about 1.5 gsm to about 15.5 gsm. In certain embodiments, the add-on weight may be about 2.9 gsm to about 10.9 gsm. In other embodiments, the add-on weight may be about 14 gsm to about 15.5 gsm. The add-on weight was measured by weighing the fiber layer prior to application of the silicone-based coating and then weighing the fiber layer again after the coating was applied to the fibers and dried thereon.

In various embodiments, the fibers in the layer have a basis weight of about 30 gsm to about 300 gsm, or about 60 gsm to about 200 gsm, or about 80 gsm to about 100 gsm, or about 85 gsm to about 95 gsm, or about 90 gsm. The silicone-based coating may be at least about 1.5% of the total weight of the layer, or between about 1.5% and about 20%, or about 1.5% to about 15%. The total weight of the fibers and the silicone-based coating may be about 61 gsm to about 215 gsm, or about 81 gsm to about 125 gsm, or about 86 gsm to about 120 gsm, or about 91 gsm to about 115 gsm.

The fibers can be manufactured by any suitable method, including, without limitation, meltblown, spunbond or spunlace, bicomponent spunbond, heat-bonded, carded, air-laid, wet-laid, extrusion, co-formed, needlepunched, stitched, hydraulically entangled or combinations thereof. In certain embodiments, the fibers are spunbond or meltblown fibers.

In an exemplary embodiment, the fibers comprise continuous spunbond fibers. Spunbond media is generally more cost effective than other manufacturing methods because it involves a relatively high throughput of the fibers.

In certain embodiments, the filter media comprises a nonwoven material that includes a substrate, sheet, layer, film, web, or other media comprising fibers. The nonwoven fiber layer discussed herein may comprise a structure of individual fibers or threads that are interlaid, interlocked, or bonded together. Nonwoven fabrics may include sheets or web structures bonded together by entangling fiber or filaments (and by perforating films) mechanically, thermally, or chemically. They may be substantially flat, porous sheets that are made directly from separate fibers or molten plastic or plastic film.

The fibers contemplated may have many shapes in cross-section, including without limitation, circular, kidney bean, dog bone, trilobal, barbell, bowtie, star, Y-shaped, and others. These shapes and/or other conventional shapes may be used with the embodiments to obtain the desired performance characteristics. The fibers stay connected to each other through thermal bonds and chemical bonds (air through or point bonded or ultrasonically bonded), by being entangled with one another, through the use of binding agents, such as adhesives, or the like.

The fibers may be artificial or natural. Suitable materials for the fibers include, but are not limited to, polyethylene terephthalate (PET), polypropylene (PP), polyester, coPET, polypropylene, polycaprolactam, polyamides, such as polyamide 6 (PA6), polyamide 6-6 (PA6-6), co-polyamides, polyesters, polyethylene, high density polyethylene (HDPE), polycarbonate, polyacrylate, polyacrylonitrile, polystyrene, styrene maleic anhydride, propylene, polyimide, polyether ketone, cellulose ester, polyamide, polylactic acid, acrylic, vinyl acetate, ethylene vinyl acetate, styrene-butadiene, ethylene/vinyl chloride, vinyl acetate copolymer, latex, epoxy, polyurethane, cellulose, styrene and combinations thereof. Other conventional fiber materials are contemplated. In an exemplary embodiment, the fibers comprise PET.

Bicomponent fibers may be used, particularly with mechanical filtration, and these are formed by extruding two polymers from the same spinneret with both polymers contained within the same filament. The fibers may include biocomponent fibers that include two or more different fibers bonded to each other. The fibers may comprise the same material or different materials. Suitable materials for bicomponent fibers include, but are not limited to, polypropylene (PP)/polyethylene (PE), polyethylene terephthalate (PET)/polypropylene (PP), HDPE/PET, PP/PET, CoPET/PET, PLA/PLA, mPP/iPP and the like.

In some embodiments, the fiber layer may comprise a “high loft” nonwoven material comprising spunbond or air through bonded carded nonwoven fibers. As used here in the term “high loft” means that the volume of void space is greater than the volume of the total solid. In air through bonded carded nonwoven fibers, the loftiness of a fiber layer can be controlled by various means known to those of skill in the art. For example, loftiness can be increased by applying less compression force onto the media during bonding. In another example, a high loft nonwoven material can be manufactured with fibers having larger thicknesses, such as thicknesses greater than 3 denier, e.g., 5 denier or greater, 6 denier or greater (discussed in more detail below). In other embodiments, the loftiness may be increased by using eccentric biocomponent fibers.

The fibers may have thicknesses that are suitable for the application. In some embodiments, the fibers have at least one dimension in the range of about 1 to about 10,000 micrometers or about 1 to about 1,000 micrometers or about 10 to 100 micrometers. The thickness of the fibers may also be measured in denier, which is a unit of measure in the linear mass density of fibers. In some embodiments, the fibers may have a linear density of about 1 denier to about 10 denier.

In certain embodiments, a filter media may include at least two different fiber thicknesses or linear densities to provide at least two different layers of the filter within the same filter media. In certain embodiments, the filter media may include three or more separate portions or layers with different denier fiber ranges within each portion.

In some embodiments, the fiber layer may compromise additives, such as antibacterial and/or antiviral compositions such as silver, zinc, copper, organosilicone, tributyl tin, organic compounds that contain chlorine, bromine, or fluorine compounds.

In certain embodiments, the fibers may be electrostatically charged such that, for example, contaminants are captured both with mechanical and electrostatic filtration. The fibers can be electrostatically charged using triboelectric methods, corona discharge, electrostatic fiber spinning, hydro charging, charging bars or other known methods. Corona charging is suitable for charging monopolymer fiber or fiber blend, or fabrics. Tribocharging may be suitable for charging fibers with dissimilar electronegativity. The electrostatic or electret fibers may comprise high loft triboelectric filter media made by carding and needling. Electrostatic fiber spinning combines the charging of the polymer and the spinning of the fibers as a one-step process. One suitable method for triboelectric charging is described in U.S. Pat. No. 9,074,301, the entire disclosure of which is hereby incorporated by reference herein for all purposes.

In certain embodiments, the nonwoven materials discussed herein may be included as part of a filter device that traps or absorbs contaminants, such as a liquid filter, a gas filter for home and commercial air filtration (e.g., HVAC), a surgical mask, or other face covering or the like. The filter device may be a mechanical filter, absorption filter, sequestration filter, ion exchange filter, reverse osmosis filter, surface filter, depth filter or the like, and may be designed to remove many different types of contaminants from the air, water, or others.

In some embodiments, the filter media may be scored, pleated, or folded into a pleated filter. The pleats may be formed by various conventional pleating operations that include, but are not limited to, bar, rotary, and star gear pleating operations.

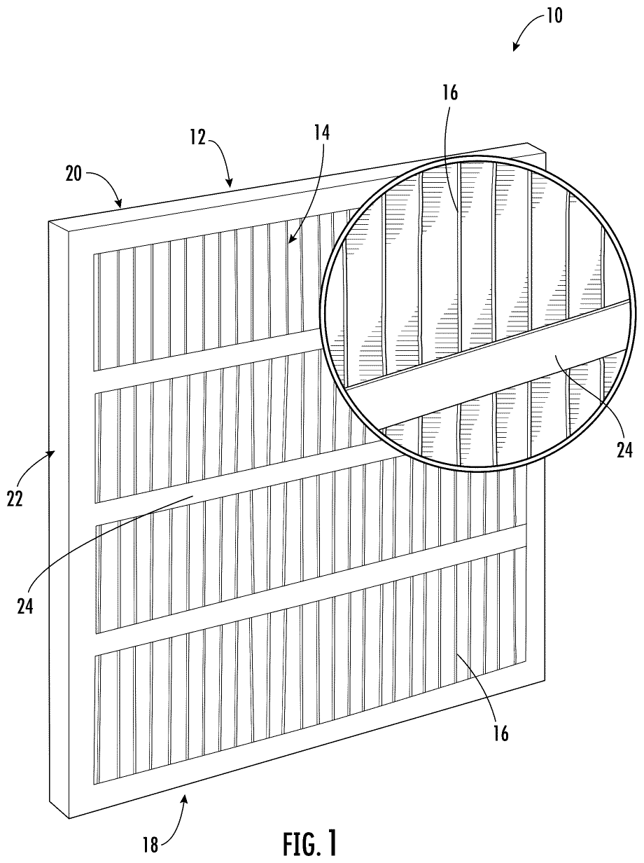

Referring now to FIG. 1, a self-supporting air filter 10 according to one embodiment generally comprises an outer frame 12 and a filter media 14. Filter media 14 comprises a plurality of pleats 16 extending in a substantially linear direction from a first end 18 of frame 12 to a second end 20. Frame 12 may comprise any standard frame used in self-supporting air filters, such as a HEPA filter, and generally includes an outer support 22 that surrounds filter media 14 and a plurality of horizontal support bars 24 that extend across filter media 14. Frame 12 may be suitable coupled to filter media 14 with conventional adhesives.

Filter media 14 comprises a plurality of continuous spunbond fibers that have been coated with the silicone-based coating described herein. The pleats 16 in filter media are self-supporting, meaning that filter media 14 does not include a metal wire backing to hold the shape of the pleats. The media 14 preferably has a Gurley stiffness of about 1,000 mg to about 16,000 mg in machine direction (MD), or about 2,500 mg to about 16,000 mg, or about 3,000 mg to about 16,000. The Gurly stiffness is calculated using a Gurley stiffness tester meeting industry standards TAPPI #T543 OM-16 (2016) and ASTM D6125-97 (2007). These filters are more environmentally friendly because do not contain metal and thus are fully incinerable.

Conventional home and commercial air filters, such as the HEPA, pleated filter 10 shown in FIG. 1, are typically rated by the filter's ability to capture particles between about 0.3 and 10 microns. This rating, referred to as a Minimum Efficiency Reporting Value or MERV is developed by the American Society of Heating, Refrigerating and Air Conditioning Engineers (ASHRAE). The MERV ratings range from 1-16, with higher values indicating higher efficiencies at trapping specific types of particles. It is also common to compare efficiency values in depending on particle sizes within the air stream during testing. E3, E2 and E1 values refer to particulate efficiency at 3-10 microns, 1-3 microns, and 0.3 to 1 micron, respectively.

The MERV rating of the filter media discussed herein will vary based on many factors, including the types and sizes of fibers used in the filter media, the width of the filter media, the number and size of pleats (if any), and the like. Likewise, the pressure drop across the filter media will also depend on many factors, including those mentioned above.

In certain embodiments, the filter media comprising fibers coated with the silicon-based coating described herein may be used to manufacture self-supported, pleated air or HVAC filters with at least a minimum efficiency rating (MERV) of about MERV 5 or about MERV 8 according to ASHRAE 52.2. In some embodiments, the MERV rating is MERV 9, or MERV 10.

In certain embodiments, the silicone-based coating increases the efficiency of a filter media in capturing contaminants in the E2 and/or E3 particle groups compared to a filter media devoid of the silicone-based coating. In these embodiments, the MERV rating of the filter media may be increased solely through the application of the silicone-based coating.

In various embodiments, the filter media has an E3 filtration efficiency of about 30%, or at least about 50%, or at least about 60%. In some embodiments, the filter media has an E3 filtration efficiency of greater than about 70%. In embodiments, the filter media comprises an improvement in an E3 filtration efficiency of about 150% or more, or about 200% or more, or about 300% or more, compared to an E3 filtration efficiency value of fibers devoid of the silicone-based coating.

The filter media has an E2 filtration efficiency of at least about 20%, or at least about 25%, or at least about 30%, or at least about 35%. In some embodiments, the filter media has E2 filtration efficiency of greater than 40%. In embodiments, the filter media comprises an improvement in an E2 filtration efficiency of about 50% or more, or about 75% or more, or about 100% or more, compared to an E2 filtration efficiency value of fibers devoid of the silicone-based coating.

The silicone-based coating is applied by any suitable process including, but not limited to, spraying the fibers with the silicone-based coating, dipping the fibers in a vessel containing the silicone-based coasting, applying the silicone-based coating as a foam to the fibers, utilizing a metering rod or other leveling device to apply the coating, delivering the coating on the fibers with a coating head, such as a slot-die, or any combination of these techniques.

In certain embodiments, the silicone-based coating is applied by dipping or spraying.

In various embodiments, the silicon-based coating is dip coated onto the fibers and the filter media has an E3 media filtration efficiency of greater than about 70% and the filter has a MERV rating of at least 8. The dip coated fibers may have an add-on weight of about 1 gsm to about 20 gsm, or about 2.9 gsm to about 10.9 gsm. The dip coated fibers may have a pressure drop of about 0.11 to about 0.126 inch H²O.

In an exemplary embodiment, the coating is sprayed onto the fibers. The silicon emulsion described above has a relatively low viscosity and therefore creates a fine mist that is particularly suitable for spraying. Spray coating is particularly cost effective and energy efficient because it does not use as much water as other methods and is relatively easy to dry. In addition, spray coating is environmentally friendly because it uses less water and does not require the use of additional chemicals. The filter media incorporating the spray coated fibers may have has an E3 filtration efficiency of at least about 75%, an E2 filtration efficiency of at least about 41%, and the filter may have a MERV rating of at least 8, or 9. The spray coated fibers may have an add-on weight of about 1 gsm to about 20 gsm, or about 14 gsm to about 15.5 gsm.

In embodiments, the filter media comprises a pressure drop of about 0.10 inch H²O to about 0.2 inch H²O at 180 fpm, or about 0.11 inch H²O to about 0.13 inch H²O at 180 fpm. The filter media may have an air permeability of about 300 cfm to about 700 cfm at 125 Pa, or about 490 cfm to about 540 cfm at 125 Pa. In embodiments, the filter media comprises a pressure drop tested that is less than 20% more than the pressure drop of a filter media devoid of the silicone-based coating. In embodiments, the pressure drop is less than 10% or less than 5% the pressure drop of a filter media devoid of the silicone-based coating.

In one embodiment, the coating is preferably applied directly to the fibers after forming a fibrous web. Applicant has discovered that applying the coating directly to fibers (as opposed to applying it to a surface of the already-formed filter media) increases the overall efficiency of the filter media, particularly at capturing contaminants in the E2 or E3 particle groups. In other embodiments, the coating can be applied to the fibers during web formation or after the nonwoven material is created (i.e., as a post-processing or post-treatment step).

The coating may be applied as a spin finish, or after a spin finish has been applied. The coating may be applied to naked fibers that have no spin finish. The coating may be applied to the staple fibers on which a typical spin finish is already applied. In certain embodiments, the staple fibers have a conventional spin finish of less than about 2%. The spin finish may include but is not limited to, lubricants, emulsifiers, antistats, anti-microbial agents, cohesive agents, and wetting agents. Other organic liquids, such as alcohols or blends of organic liquids may be added to the spin finish.

Other types of filters that may be developed with the nonwoven material disclosed herein include conical filter cartridges, square end cap filter cartridges, pocket filters, V-bank compact filters, panel filters, flat cell filters, pleated or unpleated bag cartridge filters, and the like.

### Examples

The applicant conducted four separate experiments with various fibers in a filter media. The fibers were continuous spunbond fibers thermally bonded together and calendered. The fibers comprised PET. The testing measured the pressure drop across each filter media at 180 fpm in inches H²O, the air permeability (cfm) at 125 Pa and the initial fractional efficiency percentage of the filter media for three separate particle groups: (1) E1 particles having a size of about 0.3 microns to 1 micron; (2) E2 particles having a size of about 1 micron to 3 microns; and (3) E3 particles having a size of about 3 microns to about 10 microns. All MERV ratings (based on flat sheet fractional efficiency testing) reported here are predicted MERV ratings.

The coating included a silicone compound of reactive silicone macroemulsion, a non-wetting thermodegradable surfactant/foaming agent, and water. The fibers were pad finished (although in some cases no finish was applied) and the coating was applied by dipping the fibers in a vessel containing the silicone-based coating and then allowing the fibers to dry for 3 minutes at 240 degrees F. The sample sizes had a width of 8.268 inches and a length of 11.693 inches. The sample weights were in the range of about 6.14 g to 6.32 g. The uncoated filter media had a basis weight of about 90 gsm (plus or minus about 3 gsm). The silicone coatings had a range of about 2.9 gsm add-on weight to about 10.9 gsm add-on weight and thus were about 3% to about 11% by weight of the total weight of the finished product (i.e., fibers plus silicone coating).

TABLES 1 and 2 illustrate the results of the first trial. This trial was conducted for a set of samples and the average initial fractional efficiency percentage for each particle group is reported. The initial fractional efficiency percentage was tested at 180 fpm (feet per minute air velocity). The basis weight reported in TABLE 1 includes the total weight of the filter media with the silicone coating with an initial uncoated weight of about 90 gsm (plus or minus 3 gsm). TABLE 2 reports the results with uncoated fibers, which were also continuous spunbond fibers thermally bonded together and calendered. The samples were tested on a flat sheet and the MERV ratings are predicted MERV ratings for filters containing these samples based on the fractional efficiency percentages. All of the results below were obtained with a single layer of continuous spunbond fibers.

TABLE 1

| | Pressure Drop | | | | Air | Basis | Predicted |
|---|---|---|---|---|---|---|---|
| Coated | (inch H²O) | E1 | E2 | E3 | Permeability | Weight | MERV |
| Samples | at 500 CFM | (%) | (%) | (%) | (cfm) | (gsm) | Rating |
| Sample 1 | 0.1212 | 0.0 | 38.1 | 75.6 | 491.5 | 101.3 | 9 |
| Sample 2 | 0.1169 | 1.7 | 35.4 | 72 | 512 | 99.0 | 8 |
| Sample 3 | 0.1263 | 1.6 | 41.4 | 77.6 | 534 | 98.4 | 9 |
| Sample 4 | 0.1224 | 1.7 | 39.4 | 72.8 | 536 | 98.6 | 8 |
| Sample 5 | 0.1216 | 1.1 | 38.7 | 72.8 | 529 | 100.2 | 9 |
| Average | 0.1217 | 1.2 | 38.6 | 75.3 | 520.5 | 99.5 | 9 |

TABLE 2

| | Pressure Drop | | | | Air | Basis | Predicted |
|---|---|---|---|---|---|---|---|
| Uncoated | (inch H²O) | E1 | E2 | E3 | Permeability | Weight | MERV |
| Samples | at 500 CFM | (%) | (%) | (%) | (cfm) | (gsm) | Rating |
| Sample 1 | 0.1145 | 1.3 | 15.7 | 14.1 | 520.5 | 91.2 | 4 |
| Sample 2 | 0.1078 | 2.5 | 19.8 | 21.1 | 518 | 91.8 | 5 |
| Sample 3 | 0.1106 | 2.7 | 20.9 | 22.7 | 592.5 | 93.8 | 5 |
| Average | 0.1151 | 2.2 | 18.8 | 19.3 | 543.7 | 92.3 | 4 |

As shown, all of the coated samples had a predicted MERV rating of at least 8 with an average rating of MERV 9, whereas the noncoated samples had a predicted MERV rating of 4 or 5. The capture efficiency in the E2 particle group averaged 38.6 and in the E3 particle group averaged 75.3, which is a substantial improvement over the noncoated samples (average of 18.8% in the E2 particle group and 19.3% in the E3 particle group). This represents a 100% improvement in E2 capture efficiency and a 390% improvement in E3 capture efficiency. The average pressure drop was 0.1217 (inch H²O) at 500 CFM which was substantially the same as the pressure drop in the noncoated samples (i.e., 0.1151 (inch H²O) at 500 CFM). In addition, the air permeability was substantially the same (average of 520 cfm in the coated samples with an average of 543.7 in the uncoated samples). Thus, the coated samples significantly improved the particle capture efficiency in the E2 and E2 particle groups without compromising the pressure drop or air permeability of the filter media.

TABLE 3 illustrates the results of the second trial. The five coated samples shown in TABLE 1 were retested. As shown, the testing confirmed the results of the first trial.

TABLE 3

| Coated | Pressure Drop | | | | Basis | Predicted |
|---|---|---|---|---|---|---|
| Samples | (inch H²O) | E1 | E2 | E3 | Weight | MERV |
| (Retest) | at 500 CFM | (%) | (%) | (%) | (gsm) | Rating |
| Sample 1 | 0.1251 | 1.3 | 36.3 | 72.3 | 101.3 | 8 |
| Sample 2 | 0.1157 | 0.4 | 34.6 | 72.6 | 99.0 | 8 |
| Sample 3 | 0.1236 | 1.1 | 37.6 | 75.5 | 98.4 | 9 |
| Sample 4 | 0.1149 | 0.9 | 36.5 | 73.1 | 98.6 | 8 |
| Sample 5 | 0.1224 | 1.1 | 36.3 | 77.1 | 100.2 | 9 |
| Average | 0.1203 | 1.0 | 36.3 | 74.3 | 99.5 | 8 |

Applicant conducted a third trial wherein the five coated samples were retested a second time (TABLE 4) with add-on silicone coatings ranging from about 9.0 gsm to about 10.9 gsm and the three uncoated samples were retested a second time (TABLE 5). In addition, Applicant tested an additional 16 samples with silicone coatings ranging from about 2.9 add-on gsm to about 7.2 add-on gsm (TABLE 6).

TABLE 4

| Coated | Pressure Drop | | | | | Basis | Predicted |
|---|---|---|---|---|---|---|---|
| Samples | (inch H²O) | E1 | E2 | E3 | Coating Add- | Weight | MERV |
| (2^{nd} Retest) | at 500 CFM | (%) | (%) | (%) | On (gsm) | (gsm) | Rating |
| Sample 1 | 0.1224 | −0.1 | 38.0 | 73.8 | 10.9 | 101.3 | 8 |
| Sample 2 | 0.1157 | −0.3 | 35.1 | 74.1 | 10.9 | 99.0 | 8 |
| Sample 3 | 0.1259 | 0.6 | 40.6 | 77.8 | 10.3 | 98.4 | 9 |
| Sample 4 | 0.1157 | 0.5 | 36.8 | 72.2 | 9.6 | 98.6 | 8 |
| Sample 5 | 0.1196 | −0.5 | 36.8 | 78.1 | 9.0 | 100.2 | 9 |
| Average | 0.1199 | 0.1 | 37.4 | 75.2 | 10.14 | 99.5 | 9 |

TABLE 5

| Uncoated | Pressure Drop | | | | | Basis | Predicted |
|---|---|---|---|---|---|---|---|
| Samples | (inch H²O) | E1 | E2 | E3 | Coating Add- | Weight | MERV |
| (Retest) | at 500 CFM | (%) | (%) | (%) | On (gsm) | (gsm) | Rating |
| Sample 1 | 0.1145 | 0.3 | 16.2 | 18.0 | 0 | 91.2 | 4 |
| Sample 2 | 0.1102 | 1.8 | 18.5 | 23.0 | 0 | 91.8 | 5 |
| Sample 3 | 0.1098 | 2.1 | 20.4 | 24.4 | 0 | 93.8 | 5 |
| Average | 0.1148 | 1.4 | 18.4 | 21.8 | 0 | 92.3 | 5 |

TABLE 6

| | Pressure | | | | Coating | |
|---|---|---|---|---|---|---|
| | Drop (inch | | | | Add- | Predicted |
| Coated | H²O) | E1 | E2 | E3 | On | MERV |
| Samples | at 500 CFM | (%) | (%) | (%) | (gsm) | Rating |
| Sample 6 | 0.1137 | 0.2 | 36.8 | 74.3 | 7.2 | 8 |
| Sample 7 | 0.1192 | −0.4 | 35.1 | 70.8 | 7.0 | 8 |
| Sample 8 | 0.1196 | −0.3 | 37.4 | 73.3 | 6.7 | 8 |
| Sample 9 | 0.1122 | −0.8 | 33.9 | 73.1 | 6.7 | 8 |
| Sample 10 | 0.1165 | −1.2 | 36.0 | 74.1 | 6.6 | 8 |
| Sample 11 | 0.1161 | −1.0 | 35.4 | 75.5 | 5.1 | 9 |
| Sample 12 | 0.1185 | −1.4 | 37.6 | 75.9 | 5.0 | 9 |
| Sample 13 | 0.1188 | −0.6 | 38.3 | 74.8 | 5.0 | 8 |
| Sample 14 | 0.1165 | −0.8 | 37.0 | 76.9 | 4.8 | 9 |
| Sample 15 | 0.1161 | −1.3 | 35.0 | 75.1 | 4.8 | 8 |
| Sample 16 | 0.1157 | −0.1 | 35.5 | 73.0 | 3.2 | 8 |
| Sample 17 | 0.1177 | 0.4 | 35.8 | 72.8 | 3.2 | 8 |
| Sample 18 | 0.1157 | −1.5 | 32.5 | 69.7 | 3.0 | 7 |
| Sample 19 | 0.1106 | −0.4 | 34.5 | 70.7 | 2.9 | 8 |
| Sample 20 | 0.1141 | −0.6 | 35.0 | 70.6 | 2.9 | 8 |
| Average | 0.1199 | 0.6 | 37.4 | 75.2 | | 9 |

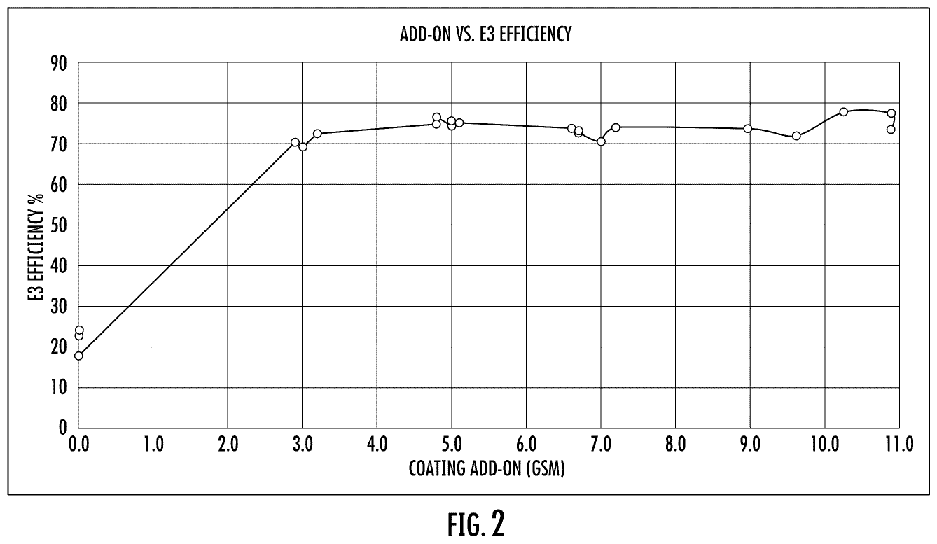

As shown in TABLE 6, Applicant demonstrated that add-on coatings ranging from 2.9 gsm to 7.2 gsm demonstrated similar performance improvements in E2 and E3 particle group efficiency and predicted MERV ratings as the add-coating that ranged from 9.0 gsm to 10.9 gsm. FIG. 2 is a graph of the results from TABLE 6 illustrating the E3 efficiency percentage versus coating add-on (gsm). The predicted MERV 8 rating is at a 70% E3 efficiency percentage. As shown, the filter media reached or exceeded predicted MERV 8 with all add-on coating amounts. FIG. 2 also illustrates the significant increase in E3 efficiency percentage with the coating compared to the uncoated samples. Thus, Applicant has demonstrated superior performance with the silicone coating ranging from add-on amounts of 2.9 gsm to 10.9 gsm.

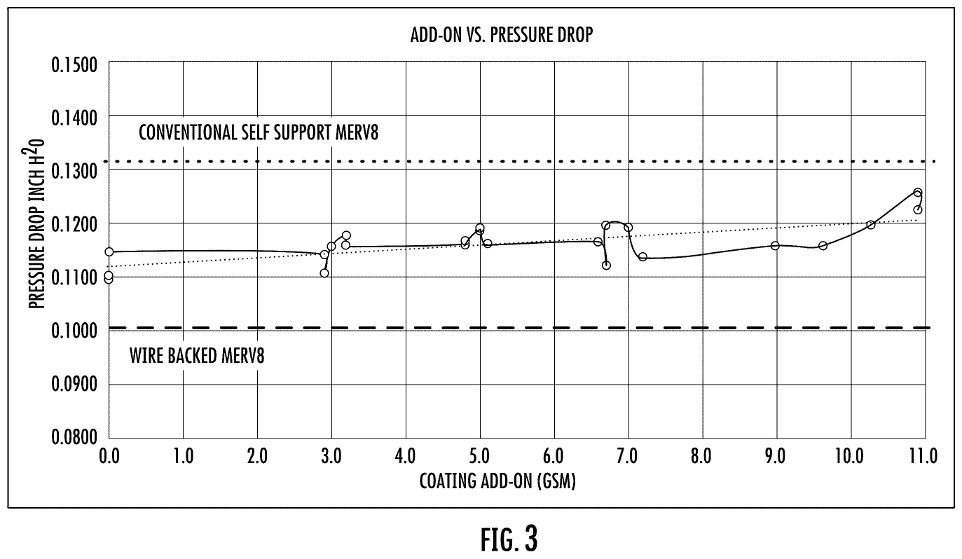

FIG. 3 is a graph of the results of the pressure drop versus add-on silicone coatings. As shown, the pressure drop ranged from about 0.11 to about 0.125 inch H²O. A standard wire-backed MERV 8 filter media typically has a pressure drop of about 0.100 inches H²O (shown in dotted lines at the bottom). Conventional self-supporting MERV 8 filter media (i.e., without the wire backing) typically demonstrate a pressure drop of about greater than 0.130 inches H²O (see the dotted line in FIG. 3, TABLE 8 and the discussion below). These commercial self-supporting filter medias are typically formed with 130 gsm carded air-through bonded fibers, which is more costly than the spunbond process described herein. In addition, the commercial self-supporting filters typically have a higher pressure drop than the samples tested herein.

TABLE 7 below is summary of the testing results for the second retest of the first five samples, the retest of the uncoated samples and the first test of the remaining samples.

TABLE 7

| SAMPLE | Add-on (gsm) | PD (inch H²O) | E3% |
|---|---|---|---|
| Coated Sample 1: | 10.9 | 0.1224 | 74 |
| retest 2 | | | |
| Coated Sample 3: | 10.9 | 0.1259 | 78 |
| retest 2 | | | |
| Coated Sample 5: | 10.3 | 0.1196 | 78 |
| retest 2 | | | |
| Coated Sample 4: | 9.6 | 0.1157 | 72 |
| retest 2 | | | |
| Coated Sample 2: | 9.0 | 0.1157 | 74 |
| retest 2 | | | |
| Coated Sample 6 | 7.2 | 0.1137 | 74 |
| Coated Sample 7 | 7.0 | 0.1192 | 71 |
| Coated Sample 8 | 6.7 | 0.1196 | 73 |
| Coated Sample 9 | 6.7 | 0.1122 | 73 |
| Coated Sample 10 | 6.6 | 0.1165 | 74 |
| Coated Sample 11 | 5.1 | 0.1161 | 75 |
| Coated Sample 12 | 5.0 | 0.1185 | 76 |
| Coated Sample 13 | 5.0 | 0.1188 | 75 |
| Coated Sample 14 | 4.8 | 0.1165 | 77 |
| Coated Sample 15 | 4.8 | 0.1161 | 75 |
| Coated Sample 16 | 3.2 | 0.1157 | 73 |
| Coated Sample 17 | 3.2 | 0.1177 | 73 |
| Coated Sample 18 | 3.0 | 0.1157 | 70 |
| Coated Sample 19 | 2.9 | 0.1106 | 71 |
| Coated Sample 20 | 2.9 | 0.1141 | 71 |
| Uncoated Sample 1- | 0.0 | 0.1145 | 18 |
| Retest | | | |
| Uncoated Sample 2- | 0.0 | 0.1102 | 23 |
| Retest | | | |
| Uncoated Sample 3- | 0.0 | 0.1098 | 24 |
| Retest | | | |

Referring now to TABLE 8 below, Applicant conducted another series of tests that included: (1) a wire backed MERV 8 filter media (labeled “Wired Backed”); (2) three different commercial self-supporting MERV 8 filter media with carded and air-through bonded fibers having a basis weight of about 130 gsm (labeled Commercial Self-Support 1-3); (3) the uncoated spunbond fibers (labeled “Uncoated”); (4) fibers coated with the silicone-based coating wherein the coating was applied by dipping the fibers in a vessel containing the silicone-based coating and then allowing the fibers to dry for 3 minutes at 240 degrees F. (labeled “Dip”); (5) fibers coated with the silicone-based coating with a metering rod (labeled “Rod”); (6) fibers coated with the silicone-based coating by dissolving the silicone into a precursor solution or slurry and delivering it onto the surface of the fibers through a precise coating head known as a slot-die (labeled “Slot-Die”); (7) fibers coated with the silicone-based coating by foam coating (labeled “Foam”); (8) fibers coated with the silicone-based coating with both a metering rod and the foam coating technique (labeled “Foam+Rod”); (9) fibers coated with the silicone-based coating by spray coating (labeled “Spray”).

TABLE 8

| Coating | | Add on | PD (inch | | | | Predicted |
|---|---|---|---|---|---|---|---|
| Method | Sample | (gsm) | H²O) | E1% | E2% | E3% | MERV |
| N/A | Wire | N/A | 0.1 | 0 | 30 | 72 | 8 |
| | Backed | | | | | | |
| N/A | Commercial | N/A | 0.132 | 0.8 | 35.3 | 70.5 | 8 |
| | Self- | | | | | | |
| | Support #1 | | | | | | |
| N/A | Commercial | N/A | 0.137 | 2.1 | 37.9 | 73.1 | 8 |
| | Self- | | | | | | |
| | Support #2 | | | | | | |
| N/A | Commercial | N/A | 0.136 | 2.5 | 37.5 | 70.0 | 8 |
| | Self- | | | | | | |
| | Support #3 | | | | | | |
| Uncoated | Sample 1 | 0.0 | 0.115 | 1.3 | 15.7 | 18.0 | 4 |
| | retest | | | | | | |
| Uncoated | Sample 2 | 0.0 | 0.110 | 2.5 | 19.8 | 23.0 | 5 |
| | retest | | | | | | |
| Uncoated | Sample 3 | 0.0 | 0.110 | 2.7 | 20.9 | 24.4 | 5 |
| | retest | | | | | | |
| Dip | Coated #1 | 10.9 | 0.122 | 0.0 | 38.1 | 73.8 | 8 |
| Dip | Coated #2 | 10.9 | 0.126 | 1.6 | 41.4 | 77.8 | 9 |
| Dip | Coated #3 | 10.3 | 0.120 | 1.1 | 38.7 | 78.1 | 9 |
| Dip | Coated #4 | 9.6 | 0.116 | 1.7 | 39.4 | 72.2 | 8 |
| Dip | Coated #5 | 9.0 | 0.116 | 1.7 | 35.4 | 74.1 | 8 |
| Dip | Coated #6 | 7.2 | 0.114 | 0.2 | 36.8 | 74.3 | 8 |
| Dip | Coated #7 | 7.0 | 0.119 | −0.4 | 35.1 | 70.8 | 8 |
| Dip | Coated #8 | 6.7 | 0.120 | −0.3 | 37.4 | 73.3 | 8 |
| Dip | Coated #9 | 6.7 | 0.112 | −0.8 | 33.9 | 73.1 | 8 |
| Dip | Coated #10 | 6.6 | 0.117 | −1.2 | 36.0 | 74.1 | 8 |
| Dip | Coated #11 | 5.1 | 0.116 | −1.0 | 35.4 | 75.5 | 9 |
| Dip | Coated #12 | 5.0 | 0.119 | −1.4 | 37.6 | 75.9 | 9 |
| Dip | Coated #13 | 5.0 | 0.119 | −0.6 | 38.3 | 74.8 | 8 |
| Dip | Coated #14 | 4.8 | 0.117 | −0.8 | 37.0 | 76.9 | 9 |
| Dip | Coated #15 | 4.8 | 0.116 | −1.3 | 35.0 | 75.1 | 8 |
| Dip | Coated #16 | 3.2 | 0.116 | −0.1 | 35.5 | 73.0 | 8 |
| Dip | Coated #17 | 3.2 | 0.118 | 0.4 | 35.8 | 72.8 | 8 |
| Dip | Coated #18 | 3.0 | 0.116 | −1.5 | 32.5 | 70.0 | 8 |
| Dip | Coated #19 | 2.9 | 0.111 | −0.4 | 34.5 | 70.7 | 8 |
| Dip | Coated #20 | 2.9 | 0.114 | −0.6 | 35.0 | 70.6 | 8 |
| Rod | Coated #21 | 5.8 | 0.117 | 0.0 | 37.0 | 63.1 | 7 |
| Rod | Coated #22 | 4.1 | 0.109 | 0.0 | 35.0 | 62.0 | 7 |
| Rod | Coated #23 | 1.5 | 0.110 | 0.0 | 34.1 | 60.2 | 7 |
| Foam | Coated #24 | 5.9 | 0.119 | 0.0 | 39.3 | 71.6 | 8 |
| Foam | Coated #25 | 4.5 | 0.117 | 0.0 | 37.9 | 67.0 | 7 |
| Foam | Coated #26 | 1.8 | 0.112 | 0.0 | 34.4 | 59.3 | 7 |
| Slot-die | Coated #27 | 5.2 | 0.119 | 0.3 | 36.0 | 69.6 | 7 |
| Slot-die | Coated #28 | 5.2 | 0.117 | 0.7 | 36.9 | 69.2 | 7 |
| Slot-die | Coated #29 | 5.2 | 0.117 | −1.6 | 35.5 | 69.1 | 7 |
| Slot-die | Coated #30 | 7.0 | 0.114 | −0.3 | 35.5 | 70.0 | 8 |
| Slot-die | Coated #31 | 7.0 | 0.112 | −0.7 | 34.9 | 69.2 | 7 |
| Slot-die | Coated #32 | 7.0 | 0.115 | −0.6 | 35.2 | 70.0 | 8 |
| Foam + | Coated #33 | 4.9 | 0.117 | 0.6 | 37.4 | 71.4 | 8 |
| Rod | | | | | | | |
| Foam + | Coated #34 | 4.9 | 0.119 | 0.6 | 37.3 | 70.8 | 8 |
| Rod | | | | | | | |
| Foam + | Coated #35 | 4.9 | 0.117 | 1.3 | 37.0 | 71.1 | 8 |
| Rod | | | | | | | |
| Foam + | Coated #36 | 4.7 | 0.110 | 0.7 | 35.2 | 70.9 | 8 |
| Rod | | | | | | | |
| Foam + | Coated #37 | 4.7 | 0.116 | 0.5 | 36.8 | 73.2 | 8 |
| Rod | | | | | | | |
| Foam + | Coated #38 | 4.7 | 0.115 | 0.5 | 37.0 | 71.8 | 8 |
| Rod | | | | | | | |
| Spray | Coated #39 | 15.4 | 0.131 | 0.4 | 39.9 | 70.8 | 8 |
| Spray | Coated #40 | 14.4 | 0.136 | 2.6 | 41.9 | 77.6 | 9 |
| Spray | Coated #41 | 14.4 | 0.129 | 2.2 | 42.2 | 75.3 | 9 |
| Spray | Coated #42 | 15.4 | 0.130 | 2.7 | 41.1 | 73.3 | 8 |

As shown above, the commercial self-supporting filters and the wire-backed filters had a predicted MERV rating of 8 and a capture efficiency in the E2 particle group between about 30 to about 37.9 and in the E3 particle group between about 70.0 and 73.1. All of the dip coated spunbond samples tested above had similar or improved results over these commercial filters, i.e., a predicted MERV rating of at least 8, a capture efficiency in the E2 particle group of at least 34.5 and in the E3 particle group of at least about 70.0. Thus, the applicant has demonstrated that the continuous spunbond filter media having a pre-coated basis weight of about 90 gsm (plus or minus about 3 gsm) that is described herein has equivalent or superior results to both wire-backed filter media and filter media comprising carded and air-through bonded fibers having a basis weight of about 130 gsm.

The applicant also demonstrated that an add-on amount of silicone coating as low as 1.5 gsm demonstrated superior results to the uncoated samples (E2 particle efficiency of 34.1%, E3 particle efficiency of about 60% and a predicted rating of MERV 7 and a pressure drop of 0.110). In addition, the spray coated samples demonstrated significant performance advantages with add-on amounts ranging from 14.4 gsm to 15.4 gsm. Thus, the silicone coating provided a substantial performance advantage with add-on amounts ranging from about 1.5 gsm to 15.4 gsm.

In addition, it should be noted that the applicant confirmed that the pressure drop for the wire backed filter was 0.1 inch H²O and the pressure drop for the commercial self-supporting filters was greater than 0.130 inch H²O. The pressure drop for the silicone coated samples ranged from about 0.112 to about 0.126. Thus, the coated spunbond samples had a lower pressure drop than the commercial self-supporting filters. In addition, the coated spunbond samples had a pressure drop that was not substantially greater than the pressure drop of the wire backed filter, demonstrating that the silicone coated spunbond filter media provides a particle capture efficiency similar to both the wire backed and commercial self-supporting filter media, without compromising pressure drop through the media.

The applicant further notes that it was demonstrated that substantial improvements occurred in capture efficiency in the E2 and E3 particles groups with all of the different methods of coating the silicone onto the fibers. In all such techniques, the E2 capture efficiency was at least about 34% (compared to 15.7% to 20.9% with the uncoated samples) and the E3 capture efficiency was at least about 59.3% (compared to 18% to 24.4% with the uncoated samples). In addition, the predicted MERV rating for all of the methods was at least MERV 7 (compared to MERV 4 and 5 with the uncoated samples).

Finally, it is noted that certain methods of coating the silicone onto the fibers appear to be superior to other methods. For example, the dip coating method resulted in a predicted MERV rating of at least MERV 8 in all of the samples (in MERV 9 in many of the samples), whereas the metered rod method resulted in a predicted MERV rating of MERV 7. With the exception of one sample, the predicted MERV rating of the foam only samples were MERV 7. The predicted MERV rating of the slot-die method was mixed with some samples at MERV 7 and others at MERV 8. Applicant further notes that combining the metered rod and foam methods raised the MERV rating to MERV 8 for all samples. In addition, the spray method results in predicted MERV ratings of MERV 8 and MERV 9, demonstrating that the spray method appears to be as successful as the dip method.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in a first aspect, a first embodiment is a nonwoven material comprising a layer containing one or more fibers. The fibers are coated with a silicone-based coating comprising a silicone compound and having an add-on weight of at least about 1.0 gsm.

A second embodiment is the first embodiment, wherein the add-on weight is about 1.5 gsm to about 15.5 gsm.

A third embodiment is any combination of the first 2 embodiments, wherein the add-on weight is about 2.9 gsm to about 15.5 gsm.

A 4^{th} embodiment is any combination of the first 3 embodiments, wherein the silicone compound is at least about 1.5% by weight of a total weight of the layer.

A 5^{th} embodiment is any combination of the first 4 embodiments, wherein the silicone compound is between about 1.5% and about 15% by weight of a total weight of the layer.

A 6^{th} embodiment is any combination of the first 5 embodiments, wherein the layer of fibers has a basis weight of about 30 gsm to about 300 gsm.

A 7^{th} embodiment is any combination of the first 6 embodiments, wherein the basis weight is about 85 gsm to about 95 gsm.

An 8^{th} embodiment is any combination of the first 7 embodiments, wherein a total weight of the layer of fibers and the silicone-based coating is about 86 gsm to about 110 gsm.

A 9^{th} embodiment is any combination of the first 8 embodiments, wherein a width of the layer is about 10 mils to about 400 mils.

A 10^{th} embodiment is any combination of the first 9 embodiments, wherein the fibers are continuous fibers.

An 11^{th} embodiment is any combination of the first 10 embodiments, wherein the continuous fibers are spunbond fibers.

A 12^{th} embodiment is any combination of the first 11 embodiments, wherein the fibers comprise a material selected from the group consisting of polyethylene terephthalate (PET), polypropylene (PP), polyester, coPET, polypropylene, polycaprolactam, polyamides, such as polyamide 6 (PA6), polyamide 6-6 (PA6-6), co-polyamides, polyesters, polyethylene, high density polyethylene (HDPE), polycarbonate, polyacrylate, polyacrylonitrile, polystyrene, styrene maleic anhydride, propylene, polyimide, polyether ketone, cellulose ester, polyamide, polylactic acid, acrylic, vinyl acetate, ethylene vinyl acetate, styrene-butadiene, ethylene/vinyl chloride, vinyl acetate copolymer, latex, epoxy, polyurethane, cellulose, styrene and combinations thereof.

A 13^{th} embodiment is any combination of the first 12 embodiments, wherein the fibers comprise polyethylene terephthalate (PET).

A 14^{th} embodiment is any combination of the first 13 embodiments, wherein the silicone-based coating comprises a reactive silicone macroemulsion.

A 15^{th} embodiment is any combination of the first 14 embodiments, wherein the silicone-based coating comprises an amino functional polydimethylsiloxane.

A 16^{th} embodiment is any combination of the first 15 embodiments, wherein the silicone-based coating comprises polyethylene glycol monotridecyl ether.

A 17^{th} embodiment is any combination of the first 16 embodiments, wherein the amino functional polydimethylsiloxane comprises about 30 to about 40 percent by weight of the coating.

An 18^{th} embodiment is any combination of the first 17 embodiments, wherein the polyethylene glycol monotridecyl ether comprises about 5 to about 10 percent by weight of the coating.

A 19^{th} embodiment is any combination of the first 18 embodiments, wherein the silicone-based coating further comprising an antistatic agent.

A 20^{th} embodiment is any combination of the first 19 embodiments, wherein the silicone-based coating is applied to the fibers by one of dip coating, rod coating, foam coating, slot-die coating, spray coating and combinations thereof.

A 21^{st} embodiment is any combination of the first 20 embodiments, wherein the silicone-based coating is applied to the fibers by spray coating.

A 22^{nd} embodiment is any combination of the first 21 embodiments, wherein the silicone-based coating is applied to the fibers by dip coating.

A 23^{rd} embodiment is any combination of the first 22 embodiments, wherein the spunbond fibers are bicomponent fibers.

A 24^{th} embodiment is any combination of the first 23 embodiments, wherein the spunbond fibers are monocomponent fibers.

In another aspect, a gas filter product is provided comprising the nonwoven material of any of the above 22 embodiments.

In another aspect, a first embodiment is an air filter product for use in a heating, ventilation, and air conditioning (HVAC) system is provided comprising the nonwoven material of any of the above 22 embodiments.

A second embodiment is the first embodiment, comprising a filter media with one or more pleats.

A third embodiment is any combination of the first 2 embodiments, wherein the pleats are self-supporting and the filter media is devoid of metal.

A 4^{th} embodiment is any combination of the first 3 embodiments, wherein the media has a Gurley stiffness of about 1,000 mg to about 16,000 mg.

In another aspect, a first embodiment is a self-supporting filter media comprising a layer containing one or more fibers. The fibers are coated with a silicone-based coating comprising a silicone compound and having an add-on weight of at least about 1.0 gsm.

A second embodiment is the first embodiment, wherein the filter media has a Minimum Efficiency Reporting Value (MERV) rating of at least about 5.

A third embodiment is any combination of the first 2 embodiments, wherein the filter media has a MERV rating of at least about 8.

A 4^{th} embodiment is any combination of the first 3 embodiments, wherein the filter media has an E3 filtration efficiency value of at least about 50 percent.

A 5^{th} embodiment is any combination of the first 4 embodiments, wherein the filter media has an E2 filtration efficiency value of at least about 15 percent.

A 6^{th} embodiment is any combination of the first 5 embodiments, wherein the air filter has an air permeability of about 300 cfm to about 700 cfm.

A 7^{th} embodiment is any combination of the first 6 embodiments, wherein the filter media has a pressure drop of about 0.10 inch H²O to about 0.20 inch H²O.

An 8^{th} embodiment is any combination of the first 7 embodiments, wherein the layer comprises one or more self-supporting pleats.

A 9^{th} embodiment is any combination of the first 8 embodiments, wherein the media has a Gurley stiffness of about 1,000 mg to about 16,000 mg.

A 10^{th} embodiment is any combination of the first 9 embodiments, wherein the filter media is devoid of metal.

An 11^{th} embodiment is any combination of the first 10 embodiments, wherein the add-on weight is about 1.5 gsm to about 15.5 gsm.

A 12^{th} embodiment is any combination of the first 11 embodiments, wherein the add-on weight is about 2.9 gsm to about 15.5 gsm.

A 13^{th} embodiment is any combination of the first 12 embodiments, wherein the silicone compound is at least about 1.5% by weight of a total weight of the layer.

A 14^{th} embodiment is any combination of the first 13 embodiments, wherein the silicone compound is between about 1.5% and about 15% by weight of a total weight of the layer.

A 15^{th} embodiment is any combination of the first 14 embodiments, wherein the layer of fibers has a basis weight of about 30 gsm to about 300 gsm.

A 16^{th} embodiment is any combination of the first 15 embodiments, wherein the basis weight is about 85 gsm to about 95 gsm.

A 17^{th} embodiment is any combination of the first 16 embodiments, wherein a total weight of the layer of fibers and the silicone-based coating is about 86 gsm to about 110 gsm.

An 18^{th} embodiment is any combination of the first 17 embodiments, wherein the fibers are continuous fibers.

A 19^{th} embodiment is any combination of the first 18 embodiments, wherein the continuous fibers are spunbond fibers.

A 20^{th} embodiment is any combination of the first 19 embodiments, wherein the silicone-based coating comprises a reactive silicone macroemulsion.

A 21^{st} embodiment is any combination of the first 20 embodiments, wherein the silicone-based coating comprises an amino functional polydimethylsiloxane.

A 22^{nd} embodiment is any combination of the first 21 embodiments, wherein the silicone-based coating comprises polyethylene glycol monotridecyl ether.

A 23^{rd} embodiment is any combination of the first 22 embodiments, wherein the amino functional polydimethylsiloxane comprises about 30 to about 40 percent by weight of the coating.

A 24^{th} embodiment is any combination of the first 23 embodiments, wherein the polyethylene glycol monotridecyl ether comprises about 5 to about 10 percent by weight of the coating.

A 25^{th} embodiment is any combination of the first 24 embodiments, wherein the fibers comprise a material selected from the group consisting of polyethylene terephthalate (PET), polypropylene (PP), polyester, coPET, polypropylene, polycaprolactam, polyamides, such as polyamide 6 (PA6), polyamide 6-6 (PA6-6), co-polyamides, polyesters, polyethylene, high density polyethylene (HDPE), polycarbonate, polyacrylate, polyacrylonitrile, polystyrene, styrene maleic anhydride, propylene, polyimide, polyether ketone, cellulose ester, polyamide, polylactic acid, acrylic, vinyl acetate, ethylene vinyl acetate, styrene-butadiene, ethylene/vinyl chloride, vinyl acetate copolymer, latex, epoxy, polyurethane, cellulose, styrene and combinations thereof.

A 26^{th} embodiment is any combination of the first 25 embodiments, wherein the fibers comprise polyethylene terephthalate (PET).

A 27^{th} embodiment is any combination of the first 26 embodiments, wherein the silicone-based coating is applied to the fibers by one of dip coating, rod coating, foam coating, slot-die coating, spray coating and combinations thereof.

A 28^{th} embodiment is any combination of the first 27 embodiments, wherein the silicone-based coating is applied to the fibers by spray coating.

A 29^{th} embodiment is any combination of the first 28 embodiments, wherein the silicone-based coating is applied to the fibers by dip coating.

In another aspect, a gas filter product is provided comprising the self-supporting filter media of any combination of the above 29 embodiments.

In another aspect, an air filter product for use in a heating, ventilation, and air conditioning (HVAC) system is provided comprising the self-supporting filter media of any combination of the above 29 embodiments.

What is claimed is:

1. A nonwoven material comprising:
a layer containing one or more fibers; and
wherein the fibers are coated with a silicone-based coating comprising a silicone compound and having an add-on weight of at least about 1.0 gsm.

2. The nonwoven material of claim 1, wherein the add-on weight is about 1.5 gsm to about 15.5 gsm.

3. The nonwoven material of claim 1, wherein the silicone compound is between about 1.5% and about 15% by weight of a total weight of the layer.

4. The nonwoven material of claim 1, wherein the layer of fibers has a basis weight of about 30 gsm to about 300 gsm.

5. The nonwoven material of claim 1, wherein a total weight of the layer of fibers and the silicone-based coating is about 86 gsm to about 110 gsm.

6. The nonwoven material of claim 1, wherein a width of the layer is about 10 mils to about 400 mils.

7. The nonwoven material of claim 1, wherein the fibers are continuous spunbond fibers.

8. The nonwoven material of claim 1, wherein the silicone-based coating comprises a reactive silicone macroemulsion.

9. The nonwoven material of claim 1, wherein the silicone-based coating is applied to the fibers by spray coating or dip coating.

10. An air filter product for use in a heating, ventilation, and air conditioning (HVAC) system comprising the nonwoven material of claim 1.

11. The air filter product of claim 10, comprising a filter media with one or more pleats, wherein the pleats are self-supporting and the filter media is devoid of metal.

12. A self-supporting filter media comprising:
a layer containing one or more fibers; and
wherein the fibers are coated with a silicone-based coating comprising a silicone compound and having an add-on weight of at least about 1.0 gsm.

13. The self-supporting filter media of claim 12, wherein the filter media has a MERV rating of at least about 8.

14. The self-supporting filter media of claim 12, wherein the filter media has an E3 filtration efficiency value of at least about 50 percent.

15. The self-supporting filter media of claim 12, wherein the filter media has an E2 filtration efficiency value of at least about 15 percent.

16. The self-supporting filter media of claim 12, wherein the filter media has a pressure drop of about 0.10 inch H²O to about 0.20 inch H²O.

17. The self-supporting filter media of claim 12, wherein the layer comprises one or more self-supporting pleats.

18. The self-supporting filter media of claim 12, wherein the filter media is devoid of metal.

19. The self-supporting filter media of claim 12, wherein the add-on weight is about 1.5 gsm to about 15.5 gsm.

20. The self-supporting filter media of claim 12, wherein the silicone compound is at least about 1.5% by weight of a total weight of the layer.
